(19) United States
(12) Patent Application Publication
(10) Pub. No.: US 2003/0041597 A1
(43) Pub. Date: Mar. 6, 2003

(54) Drive system and method of driving

(76) Inventor: Peter Haas, Calgary (CA)

Correspondence Address: Llya Zborovsky, 6 Schoolhouse Way, Dix Hills, NY, 11746, US

(21) Appl. No.: 09/939,826

(22) Filed: Aug. 28, 2001

(51) Int. Cl. F15B 21/12

(52) U.S. Cl. 60/532

(57) ABSTRACT

A drive system has a load, a driven surface which is spaced from the load, and a mechanical connection which connects the driven surface with the load and is operative for oscillating the driven surface and the load relative to one another, so that the mechanical connection displaces the driven surface with respect to the load with a force selected such that the driven surface obtains a velocity which is at least equal to a local sonic velocity and therefore a sonic shock is created and opposes the displacement of the driven surface away from the load, and thereafter the mechanical connection displaces the load away from its initial location.

### BACKGROUND OF THE INVENTION

The present invention relates to a drive system and a method of driving, for moving or lifting an object, or for propelling a vehicle through various media, for example through air or water, or on water or ground.

Systems and methods of the above mentioned general type are known in many modifications. When an object travels faster than the speed of sound, a shock is created by compression of the air ahead of the object. This shock is demonstrated by the sonic boom associated with a high performance aircraft. Historically, it was questioned whether the aircraft would ever be able to travel faster than the speed of sound, due to the forces associated with the shock. Attempts have been made to utilize sound waves, as disclosed for example in U.S. Pat. Nos. 5,511,044; 5,317,876; 5,987,880; 4,817,892; and 4,917,335. It is believed that it is possible to improve existing drive systems and methods of driving.

### SUMMARY OF THE INVENTION

Accordingly, it is an object of present invention to provide a drive system in which the sonic shock, instead of being an impediment to travel, is utilized in order to facilitate travel.

It is also an object of the present invention to provide a method of driving in which the sonic shock, instead of being an impediment to travel, is utilized in order to facilitate travel.

In keeping with these objects and with others which will become apparent hereinafter, one feature of present invention resides, briefly stated, in a drive system which has a load; a driven surface which is spaced from said load; and a mechanical connection which connects said driven surface with said load and is operative for oscillating said driven surface and said load relative to one another so that said mechanical connection displaces said driven surface with respect to said load with a force selected such that said driven surface obtains a velocity which is at least equal to a local sonic velocity and therefore a sonic shock is created and opposes said displacement of said driven surface away from said load, and thereafter said mechanical connection displaces said load away from its initial location.

In accordance with another feature of the present invention a method of driving is proposed, which includes the steps of providing a load; arranging a driven surface to be spaced from said load; connecting said driven surface with said load by a mechanical connection which is operative for oscillating said driven surface and said load relative to one another; displacing by said mechanical connection said driven surface with respect to said load with a force selected such that said driven surface obtains a velocity which is at least equal to a local sonic velocity and therefore a sonic shock is created and opposes said displacement of said driven surface away from said load; and thereafter said mechanical connection displaces said load away from its original location.

When the system is designed and a method is performed in accordance with the present invention, then the sonic shock which is generated during a displacement of a device faster than the speed of sound facilitate the travel instead of being an impediment to travel.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a drive system of the present invention which operates in accordance with a driving method of the present invention;

FIGS. 2-4 are views showing successive steps of a drive stroke of the driving system in accordance with the present invention;

FIG. 5 is a view showing a return stroke of the system in accordance with the present invention; and

FIGS. 6 and 7 are views showing further embodiments of the invention.

### DESCRIPTION OF THE PREFERRED EMBODIMENTS

The drive system in accordance with the present invention includes a load which is identified as a whole with reference numeral 1. The load represents an object which has to be moved in the inventive system with the use of the inventive method, such as a vehicle to be propelled through various media, for example through air or water, or on water or ground, a lifting device to lift an object, an object to be lifted, etc.

The system further includes a driven surface which is identified with reference numeral 2. The driven surface 2 is an object which has a substantial area. Also, the mass of the driven surface 2 is significantly less than the mass of the load 1.

The system further has mechanical connecting means 3 for connecting the load 1 with the driven surface 2. The mechanical connecting means 3 is formed so as to create motion between the load 1 and the driven surface 2, such as for example an oscillation between the load 1 and the driven surface 2 with a high frequency. The mechanical connecting means 3 can be formed as a mechanical device for creating motion between the load 1 and the driven surface 2. For example, a rotating asymmetrical camshaft can be used to drive the driven surface 2 relative to the load 1. A more efficient mechanical connecting means 3 can be formed so as to use a piezo electric material to convert electrical energy into the required mechanical energy. An asymmetrical electrical wave form such as a sawtooth wave, can be used to drive a crystal in the desired manner.

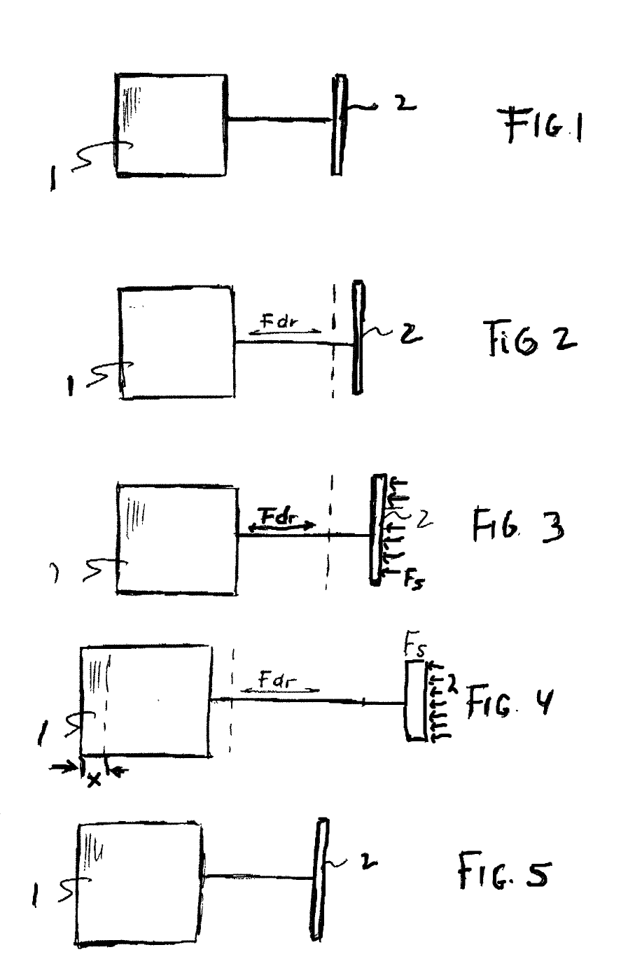

A piezo-electric crystal can be also formed so that it forms the driven surface 2, and at the same time the mechanical connecting means 3 which connects the driven surface 2 to the load 1. In order to achieve the required driven surface velocity, stacked piezo-electric elements or mechanical amplifiers can be used. The above mentioned inventive system which includes the components 1, 2, 3 is shown schematically in FIG. 1.

The system operates in the following manner:

In a first part of a drive cycle, a force is exerted between the load 1 and the driven surface 2 by the mechanical connecting means 3 to force the components away from each other as shown in FIG. 2. Since the mass of the driven surface 2 is significantly less than the mass of the load 1, the driven surface 2 is accelerated at a much greater rate than the load 1. The force is selected such that, the driven surface 2 is accelerated to a velocity equal to or greater than Mach1, the local sonic velocity. As the velocity of the driven surface 2 exceeds the local sonic velocity, its motion is opposed by a sonic shock as shown in FIG. 3. Since the sonic shock counteracts the displacement of the driven surface 2, and since the mechanical connecting means 3 continues to apply the above mentioned force, the connecting means 3 now displaces the load 1 away from its original location by a distance X as shown in FIG. 4.

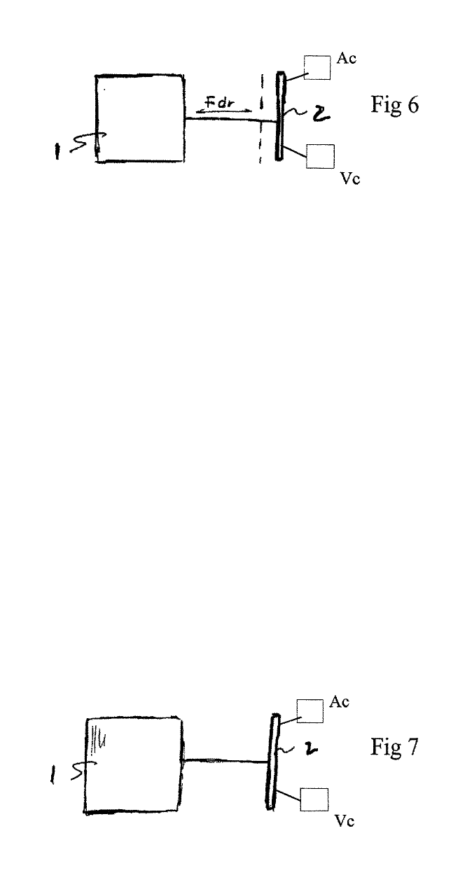

The cycle is completed by reversing the direction of the motion between the load 1 and the driven surface 2. For example, the mechanical connecting means 3 now pull the driven surface 2 and the load 1 toward one another, for example by contracting the connecting means 3, as opposed to the previous expansion of the connecting means 3 in the steps shown in FIGS. 2, 3, 4. During this stroke, the force is controlled by velocity control means VC shown in FIG. 6, so that the velocity of the driven surface 2 is less than velocity of the initial stroke. At this lower velocity, the force of the sonic shock on the device is reduced or eliminated. The load 1 and the driven surface 2 are returned to their initial positions with respect to each other. The cycle is completed and ready to start over. During this cycle the system is displaced by a finite distance as shown in FIG. 5.

The net force applied to the object over a cycle as a result of the sonic shock is greater than zero since the force applied in the forward stroke is greater than the force applied in the reverse stroke. In the above example this difference is a result of the different velocities of the driven surface during the forward and reverse strokes. It would also be possible to create different forces in the forward and reverse strokes by changing the angle of the driven surface in the forward stroke compared to the reverse stroke. The changing of the angle can be performed by any known angle controlling mechanical device AC, shown in FIG. 7, which acts on the driven surface and changes its angle.

In the example of the present invention presented herein above, in the first part of the device cycle the load 1 and the driven surface 2 are forced away from one another as shown in FIG. 2. It is of course possible that in this first part of the drive cycle the above mentioned components are forced toward one another, and in the subsequent parts of the cycle will be adjusted correspondingly.

By completing many cycles described herein above, the system can be moved a significant distance. It is conceivable that the net force created could exceed the force of gravity and the device could be used to lift or levitate a given mass.

It will be understood that each of the elements described above, or two or more together, may also find a useful application in other types of constructions differing from the types described above.

While the invention has been illustrated and described as embodied in drive system and method of driving, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A drive system, comprising a load; a driven surface which is spaced from said load; and a mechanical connection which connects said driven surface with said load and is operative for oscillating said driven surface and said load relative to one another so that said mechanical connection displaces said driven surface with respect to said load with a force selected such that said driven surface obtains a velocity which is at least equal to a local sonic velocity and therefore a sonic shock is created and opposes said displacement of said driven surface, and thereafter said mechanical connection displaces said load away from its original location.

2. A drive system as defined in claim 1, wherein said load, said driven surface and said mechanical connection are selected so that a force applied to said load during the displacement of said driven surface is greater than a force applied during the return of said driven surface to its initial location with respect to the load.

3. A drive system as defined in claim 1, wherein said driven surface has a mass, said load has a mass which is substantially greater than the mass of said driven surface so that during the displacement of said driven surface with respect to said load said driven surface is accelerated at a greater rate than said load.

4. A drive system as defined in claim 2; and further comprising means for changing a velocity of said driven surface during said displacement of said driven surface with respect to a velocity of said driven surface during said displacement of said driven surface to its initial location so as to provide said greater force during displacement of said driven surface.

5. A drive system as defined in claim 2; and further comprising means for changing an angle of said driven surface during said displacement of said driven surface with respect to said angle of said driven surface during said displacement of said driven surface to its initial location so as to provide said greater force during said displacement of said driven surface.

6. A drive system as defined in claim 1, wherein said mechanical connection is operative, after said displacement of said load away from its original location, to return said driven surface to an initial position with respect to said load.

7. A method of driving, comprising the steps of providing a load; arranging a driven surface so that it is spaced from said load; connecting said driven surface with said load and is operative for oscillating said driven surface and said load relative to one another; displacing said driven surface with respect to said load by the mechanical connection with a force selected such that said driven surface obtains a velocity which is at least equal to a local sonic velocity and therefore a sonic shock is created and opposes said displacement of said driven surface, and thereafter said mechanical connection displaces said load away from its original location.

8. A method as defined in claim 7; and further comprising applying to said load during the displacement of said driven surface a force which is greater than a force applied during the return of said driven surface to its initial location with respect to the load.

9. A method as defined in claim 7; and further comprising providing said driven surface with a mass, and said load with a mass which is substantially greater than the mass of said driven surface so that during the displacement of said driven surface with respect to said load, said driven surface is accelerated at a greater rate than said load.

10. A method as defined in claim 7; and further comprising after said displacement of said load, returning said driven surface to its original position with respect to said load by said mechanical connection.

11. A method as defined in claim 8; and further comprising changing a velocity of said driven surface with respect to a velocity of said driven surface during said return of said driven surface to its initial location so as to provide said greater force during displacement of said driven surface.

12. A method as defined in claim 8; and further comprising changing an angle of said driven surface during said displacement of said driven surface with respect to an angle of said driven surface during said return of said driven surface to its initial location to provide said greater force during said displacement of said driven surface.
